(19) United States
(12) Patent Application Publication
(10) Pub. No.: US 2014/0280795 A1
(43) Pub. Date: Sep. 18, 2014

(54) NETWORK SYSTEM, INFORMATION PROCESSING APPARATUS, AND COMPUTER PROGRAM PRODUCT

(71) Applicant: Shinya MORI, Tokyo (JP)

(72) Inventor: Shinya MORI, Tokyo (JP)

(21) Appl. No.: 14/187,511

(22) Filed: Feb. 24, 2014

(30) Foreign Application Priority Data
Mar. 15, 2013 (JP) 2013-053928

(51) Int. Cl. H04L 12/24

(52) U.S. Cl. CPC H04L 41/0803
USPC 709/220

(57) ABSTRACT

A network system includes: a first information processing apparatus that transmits a setting set by an administrator for an application program; and a second information processing apparatus connected to the first information processing apparatus via a network. The second information processing apparatus includes: a communication unit that receives the setting set by the administrator for the application program; an execution unit that executes the application program according to a setting; a setting unit that stores therein and applies a setting for the application program; a setting check unit that determines whether the set setting received by the communication unit and the setting stored in the setting unit match; and a display unit that displays that the setting check unit determines that the set setting and the stored setting do not match.

### CROSS-REFERENCE TO RELATED APPLICATIONS

The present application claims priority to and incorporates by reference the entire contents of Japanese Patent Application No. 2013-053928 filed in Japan on Mar. 15, 2013.

### BACKGROUND OF THE INVENTION

1. Field of the Invention

The present invention relates to a network system, an information processing apparatus, and a computer program product.

2. Description of the Related Art

A printer that is a multifunction peripheral, for example, is known to perform various types of processing according to settings. It is well known that, when the printer has, for example, a finishing function, a printer driver of the printer creates a preview image of a document to be printed to which the finishing function is applied, and displays the preview image on a print setting screen. A printing system is also known in which only predetermined print settings, not all the settings, are displayed on a print setting screen to prevent print setting errors efficiently.

Japanese Patent Application Laid-open No. 2007-280320 discloses, for example, a printing system that displays only predetermined print setting items among all print setting items of print setting data on a print setting screen.

The printing system, however, requires a user to specify which items are to be displayed. Moreover, in the printing system, it is difficult for an administrator who manages terminals of a plurality of users to prompt the users to use print settings recommended by the administrator.

In view of the above, there is a need to provide a network system, an information processing apparatus, and a computer program product that enable an administrator to prompt users to use settings recommended by the administrator.

### SUMMARY OF THE INVENTION

It is an object of the present invention to at least partially solve the problems in the conventional technology.

A network system includes: a first information processing apparatus that transmits a setting set by an administrator for an application program; and a second information processing apparatus connected to the first information processing apparatus via a network. The second information processing apparatus includes: a communication unit that receives the setting set by the administrator for the application program; an execution unit that executes the application program according to a setting; a setting unit that stores therein and applies a setting for the application program; a setting check unit that determines whether the set setting received by the communication unit and the setting stored in the setting unit match; and a display unit that displays that the setting check unit determines that the set setting and the stored setting do not match.

An information processing apparatus includes: an execution unit that executes, according to a setting, an application program that operates on a platform; a communication unit that receives a setting set by an administrator for the application program; a setting unit that stores therein and applies a setting for the application program; a setting check unit that determines whether the set setting received by the communication unit and the setting stored in the setting unit match; and a display unit that displays that the setting check unit determines that the set setting and a current setting do not match.

A computer program product includes a non-transitory computer-usable medium having computer-readable program codes embodied in the medium for processing information in an information processing apparatus. The program codes when executed cause a computer to execute: storing a setting for an application program that operates on a platform; receiving a setting set by an administrator for the application program; determining whether the set setting received and the stored setting match; and displaying that it is determined at the determining that the set setting and the stored setting do not match.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a configuration diagram illustrating an example of a configuration of a network system that is a management system;

FIG. 2 is a block diagram illustrating an outline of a computer program installed on a client terminal and the like;

FIG. 3 is a block diagram illustrating a configuration of a plug-in;

FIGS. 4A and 4B are a diagram and a table illustrating an operation of the client terminal to acquire a setting for a plug-in from an application server;

FIG. 5 is a screen example illustrating a state of a setting for a plug-in set by an administrator;

FIG. 6 is a table illustrating setting items for the plug-in, and access rights to respective values of the setting items;

FIG. 7 is a diagram illustrating an example of a setting screen for selecting a screen that a user wants to display on the client terminal after a print setting check;

FIG. 8 is a flowchart illustrating the operation of the client terminal performed when the client terminal is used by the user to cause an output device to perform printing;

FIG. 9 is a diagram illustrating an example of a preview screen displayed on the client terminal;

FIG. 10 is a diagram illustrating an example of a printing summary screen displayed on the client terminal;

FIG. 11 is a configuration diagram illustrating an example of a configuration of the network system according to an embodiment;

FIG. 12 is a functional block diagram illustrating an outline of functions of a user personal computer (PC);

FIG. 13 is a functional block diagram illustrating an outline of functions of an administrator PC;

FIG. 14 is a table illustrating a configuration of a management status stored in a management status database (DB);

FIG. 15 is a diagram illustrating an outline of the operation of the network system;

FIG. 16 is a table illustrating a configuration of distribution information transmitted by the administrator PC;

FIG. 17 is a table illustrating contents of a setting contained in the distribution information illustrated in FIG. 16;

FIG. 18 is a flowchart illustrating the operation of the user PC;

FIG. 19 is a flowchart illustrating the operation of a client in a comparative example in performing installation;

FIG. 20 is a flowchart illustrating the operation of the user PC in performing installation;

FIG. 21 is a flowchart illustrating the operation of the administrator PC;

FIG. 22 is a flowchart illustrating the operation of the user PC performed when the user PC requests a plug-in from a software management PC;

FIG. 23 is a flowchart illustrating the operation of the user PC performed when the software management PC transmits a plug-in to the user PC according to an instruction from the administrator PC; and

FIG. 24 is a flowchart illustrating the operation of the client in the comparative example performed when the client selects and installs a plug-in.

### DETAILED DESCRIPTION OF THE PREFERRED EMBODIMENT

### Embodiment

A management system according to an embodiment is described in detail with reference to the accompanying drawings. FIG. 1 is a configuration diagram illustrating an example of a configuration of a network system 10 as the management system. As illustrated in FIG. 1, the network system 10 is a client-server system in which an application server (software management PC) 12 is connected with an output device (shared) 16, an administrator PC 50, and a client terminal (client PC) 20 via a network 14 in a wired or wireless manner. An output device (local) 18 is connected to the client terminal 20.

The application server 12, the client terminal 20, and the administrator PC 50 are computers (information processing apparatuses) that operate by executing computer programs. The administrator PC 50 is used by an administrator to perform setting for the client terminal 20 of a user. The application server 12 stores therein software (such as a platform, plug-ins, and setting data) that will be distributed to the client terminal 20. The administrator PC 50 and the application server 12 may be integrated to constitute one computer.

The client terminal 20 is used by a user. The output device 16 is a display output device such as an image forming apparatus such as a multifunction peripheral that implements various functions according to settings, a copier, a scanner, or a projector. The output device 16 is available to (share by) a plurality of client terminals 20. The output device 18 is an image forming apparatus or the like that is locally connected to one client terminal 20 via wired or wireless communication, for example.

The network system 10 is not limited to the configuration described above, but may be configured by, for example, a plurality of application servers 12, a plurality of clients 20, and a plurality of output devices 16.

Next, the client terminal 20 is described in detail. FIG. 2 is a block diagram illustrating an outline of computer programs installed on the client terminal 20. As illustrated in FIG. 2, the client terminal 20 includes a platform 30 as the core, an application 4 that operates on the platform 30 via a platform API, and a printer driver 2. Computer programs such as the platform 30, the application 4, and the printer driver 2 may be stored in a storage unit 3.

The platform 30 includes, for example, a communication unit (transmission and reception unit) 31, a setting unit 38, and a display control unit (user interface [UI] control) 39. The communication unit 31 transmits and receives data to and from the application server 12 also serving as a web server. The setting unit 38 stores therein settings for respective plug-ins 40a to 40d of the application 4, and applies the settings to the plug-ins 40a to 40d. The display control unit 39 controls a user interface (performs UI control) that changes a setting by receiving, for example, an input operation from a user to change a setting for the client terminal 20, and displays (outputs) a screen such as a setting screen that indicates settings.

The application 4 includes, for example, the plug-ins 40a to 40d. The plug-ins 40a to 40d use functions and settings on the platform 30. Here, it is assumed that the plug-in 40a is a “printing flow” plug-in that executes a printing flow performed on the output device 16. The printer driver 2 includes a driver program for outputting printing data to the output device 16.

FIG. 3 is a block diagram illustrating a configuration of the plug-in 40a. As illustrated in FIG. 3, the plug-in 40a includes a printing flow execution unit 400, a setting check unit 402, a setting change unit 404, a preview generation unit 406, a display unit 408, and a setting storage unit 410, for example.

The printing flow execution unit 400 controls execution of the printing flow. The setting check unit 402 checks a setting on printing data. The setting change unit 404 changes the setting on printing data. The preview generation unit 406 generates a print preview image by using information on printing data and print settings. The display unit 408 displays, for example, print setting items and a print preview image on a screen. The setting storage unit 410 stores therein settings such as a print setting set by the administrator or a user.

Next, described is the operation of the client terminal 20 to acquire a setting for a plug-in from the application server 12. FIGS. 4A and 4B are a diagram and a table that illustrate the operation of the client terminal 20 to acquire a setting for a plug-in from the application server 12. As illustrated in FIG. 4A, the client terminal 20 acquires, for example, a “printing flow” plug-in setting 5 from the application server 12.

FIG. 4B is a table illustrating an example of a setting for acquiring the plug-in setting 5. The setting illustrated in FIG. 4B is stored in the setting unit 38 (FIG. 2) of the platform 30. When a setting item “use remote setting” is set, the client terminal 20 acquires, when starting up, a setting recommended and set by the administrator from the application server 12. The access right to change this setting is granted only to the administrator. The client terminal 20 acquires the plug-in setting 5 from a server described in a setting item “URL of setting server”. Each plug-in stores acquired settings in the setting storage unit 410. A different URL may be set for each predetermined group (such as a department) in the setting item “URL of setting server”.

Next, described is the process performed by the administrator to set a setting for each plug-in. FIG. 5 is a screen example illustrating a state of a setting for the plug-in 40a set by the administrator. FIG. 6 is a table illustrating setting items for the plug-in 40a, and access rights to respective values of the setting items. The administrator sets items (items to be subjected to a print setting check) that the administrator recommends to the user in the printing flow and makes the user check before printing, and stores the items in the application server 12.

In the example illustrated in FIG. 5, the administrator sets “black-and-white” printing to be a default and recommended setting with respect to a setting item “color/black-and-white”, and makes it checked by the user before printing. The administrator also sets “open to left” printing to be a default and recommended setting with respect to a setting item “duplex/binding”, and makes it checked by the user before printing. Checking whether a setting recommended and set by the administrator and a setting (setting stored in the setting unit 38) currently set on the client terminal 20 match is hereinafter referred to as the print setting check. When a setting on the client terminal 20 and a setting recommended and set by the administrator match, it is not necessary to require the user to check the setting before printing.

As illustrated in FIG. 6, only the administrator has the setting change access right to values for the setting items “color/black-and-white” and “duplex/binding”. In other words, only the administrator can recommend settings on the setting items “color/black-and-white” and “duplex/binding” to the user, and can specify that the setting items are the items required to be checked by the user before printing.

Setting items “combining” and “staple” illustrated in FIG. 5 have no default setting to be recommended to the user, and are not set to require the user to check before printing. As illustrated in FIG. 6, either of the administrator and the user can set the setting items “combining” and “staple” to be the items to be subjected to the print setting check.

As illustrated in FIG. 6, settings on the setting items are recommended and are set to be default settings by the administrator, but the settings can be set to be mandatory settings by the administrator.

FIG. 7 is a diagram illustrating an example of a setting screen for selecting a screen that the user wants to display on the client terminal 20 after the print setting check. As illustrated in FIG. 7, the user can select whether a printing summary screen (FIG. 9) to be described later, or a preview screen (FIG. 10) is displayed on the client terminal 20 after the print setting check.

Next, described is the operation of the client terminal 20 performed when the client terminal 20 is used by the user to cause the output device 16 to perform printing. FIG. 8 is a flowchart illustrating the operation of the client terminal 20 performed when the client terminal 20 is used by the user to cause the output device 16 to perform printing.

At S10, the client terminal 20 starts the printing flow in response to an instruction input of start of printing from a user. Specifically, the printing flow execution unit 400 starts the printing flow when printing data is output from the printer driver.

At S12, the client terminal 20 checks (determines) whether the print setting check is OK. More specifically, the setting check unit 402 in the client terminal 20 determines whether the current setting on the client terminal 20 matches the setting recommended and set by the administrator. When the client terminal 20 determines that the print setting check is OK (settings match) (Yes at S12), the process proceeds to S20. When the client terminal 20 determines that the print setting check is not OK (settings do not match) (No at S12), the process proceeds to S14.

Specifically, the setting check unit 402 performs the print setting check in accordance with contents of the print setting check stored in the setting storage unit 410. For example, it is assumed that the print setting check is set to check whether the black-and-white printing is set in the client terminal 20. When the color printing is currently set on the client terminal 20, the process proceeds to S14. When the black-and-white printing is currently set on the client terminal 20, the process proceeds to S20.

At S14, the client terminal 20 checks the setting of the operation after the print setting check in accordance with the setting illustrated in FIG. 7. When display of the preview screen is set, the process proceeds to S16. When display of the printing summary screen is set, the process proceeds to S18.

At S16, the client terminal 20 displays the preview screen. FIG. 9 is a diagram illustrating an example of the preview screen displayed on the client terminal 20. As illustrated in FIG. 9, the client terminal 20 displays a preview of a print image and the current setting on the plug-in 40a on the preview screen. The client terminal 20 displays, on the preview screen, a mark indicating “check OK” for a setting item in which a setting recommended and set by the administrator and a setting currently set on the client terminal 20 match. The client terminal 20 displays, on the preview screen, a mark indicating “check NG” for a setting item in which a setting recommended and set by the administrator and a setting currently set on the client terminal 20 do not match. The client terminal 20 allows the user to change a setting on a setting item on the preview screen after the user checks a mark indicating “check OK” or “check NG”.

Specifically, at S16, the preview generation unit 406 generates the print preview image, and the display unit 408 displays the print setting items and the print preview image. When the user changes a print setting, the setting change unit 404 changes the print setting.

At S18, the client terminal 20 displays the printing summary screen. FIG. 10 is a diagram illustrating an example of the printing summary screen displayed on the client terminal 20. As illustrated in FIG. 10, the client terminal 20 displays, on the printing summary screen, settings currently set on the plug-in 40a. The client terminal 20 displays, on the printing summary screen, a mark indicating “check OK” for a setting item in which a setting recommended and set by the administrator and a setting currently set on the client terminal 20 match. The client terminal 20 displays, on the printing summary screen, a mark indicating “check NG” for a setting item in which a setting recommended and set by the administrator and a setting currently set on the client terminal 20 do not match. The client terminal 20 allows the user to change, after the user checks a mark indicating “check OK” or “check NG”, a setting on a setting item on the printing summary screen.

Specifically, at S18, the display unit 408 displays the print setting items. When the user changes a print setting, the setting change unit 404 changes the print setting.

At S20, the client terminal 20 causes the output device 16 to perform printing. In other words, the client terminal 20 transfers printing data to the output device 16 in accordance with print settings. When any setting is changed on the printing summary screen or on the preview screen, the client terminal 20 causes the output device 16 to perform printing in accordance with the changed setting.

As described above, the network system (management system) 10 enable the administrator to prompt the user to use a setting recommended and set by the administrator.

Next, described in detail is distribution of a setting for a plug-in in the network system 10. FIG. 11 is a schematic diagram illustrating the network system (management system) 10. As illustrated in FIG. 11, the network system 10 is a client-server system in which, for example, user PCs 20-1 and 20-2, the administrator PC 50, and the software management (server) PC 12 are connected with one another via the network 14. The user PCs (clients) 20-1 and 20-2, the administrator PC 50, and the software management PC 12 are computers that operate by executing computer programs. The software management PC 12 stores therein software (plug-ins) to be distributed to the user PCs 20-1 and 20-2. The administrator PC 50 and the software management PC 12 may be integrated to constitute one computer.

Next, described in detail are the user PCs 20-1 and 20-2, and the administrator PC 50. When which of a plurality of components such as the user PCs 20-1 and 20-2 is described needs not be specified, the component may be simply referred to as, for example, “the user PC 20”.

FIG. 12 is a functional block diagram illustrating an outline of functions of the user PC 20. As illustrated in FIG. 12, the user PC 20 includes a platform 30 and a plurality of plug-ins 40 that operates on the platform 30.

The platform 30 includes, for example, a transmission and reception unit 31, a setting notification unit 32, a management unit 33, a global setting management unit 34, management data 35, administrator information 36, and Admin (access right information storage unit) 37.

The transmission and reception unit 31 includes a transmission unit and a reception unit, and performs communication of data such as computer programs and settings via the network 14. The setting notification unit 32 transmits notification to be described later to the administrator PC 50. The management unit 33 manages data on the platform 30. The global setting management unit 34 manages a setting (global setting) corresponding to a function overriding a function corresponding to a setting (to be described later) on a plug-in 40. The management data 35 is a database that is used to manage the plug-ins 40. The administrator information 36 stores therein administrator information that specifies the administrator who distributes distribution information to be described later with reference to FIG. 16. The Admin 37 is an access right information storage unit that stores therein access right information indicating an administrator right for each user PC 20.

Each plug-in 40 includes a function execution unit 41, a setting display unit 42, a setting management unit 43, and a setting transmission and reception unit 44. The function execution unit 41 executes a function of the plug-in. The setting display unit 42 has a function of displaying settings on the plug-in. The setting management unit 43 manages settings on the plug-in. The setting transmission and reception unit 44 transmits and receives settings to and from the plug-in.

FIG. 13 is a functional block diagram illustrating an outline of functions of the administrator PC 50. As illustrated in FIG. 13, the administrator PC 50 includes user PC management data 51, a data transmission and reception unit 52, and a management status DB 53. The user PC management data 51 is management data that is used to manage clients such as the user PCs 20-1 and 20-2. Management data in the user PC management data 51 includes, for example, IP addresses of the user PCs 20-1 and 20-2, and data indicating plug-ins installed on the user PCs. The data transmission and reception unit 52 includes a transmission unit and a reception unit, and transmits distribution information to be described later, for example. The management status DB 53 is a storage unit that stores therein management status to be described later with reference to FIG. 14.

FIG. 14 is a table illustrating a configuration of management status stored in the management status DB 53. As illustrated in FIG. 14, the management status includes, for each piece of distribution information, where distribution information is transmitted to, whether notification indicating completion of installing software corresponding to distribution information has been received, and what time the notification received was transmitted.

Next, described is an outline of the operation of the network system 10. FIG. 15 is a diagram illustrating an outline of the operation of the network system 10. As illustrated in FIG. 15, the administrator PC 50 transmits distribution information 61 to the user PC 20 via the network 14. The distribution information 61 includes a setting 62 (to be described later with reference to FIG. 17, for example). The software management PC 12 transmits a plug-in 63 to the user PC 20 via the network 14 in response to, for example, a request from the user PC 20. The software management PC 12 may be configured to transmit the plug-in 63 to the user PC 20 in response to an instruction from the software management PC 12. The distribution information 61 includes, in the header (not illustrated) thereof for example, administrator information that specifies the administrator who distributes the distribution information 61.

FIG. 16 is a table illustrating a configuration of the distribution information 61 transmitted by the administrator PC 50. As illustrated in FIG. 16, the distribution information 61 includes information specifying plug-ins, and settings (such as settings A to C) corresponding to the respective plug-ins. The distribution information 61 may include software such as a plug-in D that has no setting corresponding thereto.

FIG. 17 is a table illustrating contents of a setting (such as the setting A) contained in the distribution information 61 illustrated in FIG. 16. As illustrated in FIG. 17, the contents of a setting include setting names indicating the names of functions that vary depending on a setting, values (setting values), and setting change access rights each of which is an attribute indicating whether to permit a change in a setting (value). When “administrator” is set in a setting change access right to a setting, only the administrator can change the value of the setting (only through the administrator PC 50). For example, when “administrator/general user” is set in a setting change access right to a setting, both the administrator and a user can change the value of the setting (through the administrator PC 50, and the user PCs 20-1 and 20-2).

Next, described is the operation of the network system 10. FIG. 18 is a flowchart illustrating the operation of the user PC 20. As illustrated in FIG. 18, at S100, the user PC 20 receives distribution information (see FIGS. 16 and 17) from the administrator PC 50. In other words, the user PC 20 receives the contents of a setting (setting information) illustrated in FIG. 17.

At S102, the user PC 20 performs administrator authentication with reference to administrator information included in, for example, the header of the distribution information illustrated in FIG. 16 to determine whether the distribution information is proper information. When the user PC 20 successfully authenticates an administrator (Yes at S102), the process proceeds to S104. When the user PC 20 fails to successfully authenticate an administrator (No at S102), the process proceeds to S114.

At S104, the user PC 20 determines whether it already has a plug-in indicated in the distribution information. When the user PC 20 does not have the plug-in (No at S104), the process proceeds to S106. When the user PC 20 already has the plug-in (Yes at S104), the process proceeds to S110.

At S106, the user PC 20 receives the plug-in.

At S108, the user PC 20 installs the received plug-in. The details of the installation at S108 will be described later with reference to FIG. 20.

At S110, the user PC 20 performs setting processing on the installed plug-in by using a setting contained in the distribution information.

At S112, the user PC 20 transmits notification indicating completion of the setting processing to the administrator PC 50.

At S114, the user PC 20 deletes the received distribution information.

FIG. 19 is a flowchart illustrating the operation of a client in a comparative example in performing installation. As illustrated in FIG. 19, at S200, the client in the comparative example acquires a plug-in list from, for example, the administrator PC 50 according to an operation of a user.

At S202, the client specifies a plug-in to be installed from the plug-in list according to an operation of the user.

At S204, the client receives the specified plug-in.

At S206, the client installs the received plug-in.

As described above, the client in the comparative example installs a plug-in by the operation of a user.

Next, described in detail is the operation (S108 in FIG. 18) of the user PC 20 in performing installation. FIG. 20 is a flowchart illustrating the operation of the user PC 20 in performing installation. As illustrated in FIG. 20, at S300, the user PC 20 sets information from the Admin as authentication information. Specifically, the user PC 20 reads, from the Admin 37 (FIG. 12), access right information indicating administrator right to the user PC 20, and displays a screen for asking approval of the user whose access right information is input in advance.

At S302, the user PC 20 determines whether the administrator right has been successfully authenticated. When, for example, the user PC 20 receives an input indicating that the administrator right has been successfully authenticated (Yes at S302), the process proceeds to S304. When the administrator right has not been successfully authenticated (No at S302), the process is terminated.

At S304, the user PC 20 performs processing such as installation and setting of a specific plug-in.

At S306, the user PC 20 determines whether the processing at S304 has been completed. When the user PC 20 determines that the processing at S304 has not been completed (No at S306), the user PC 20 continues the processing at S304. When the user PC 20 determines that the processing at S304 has been completed (Yes at S306), the process proceeds to S308.

At S308, the user PC 20 transmits, to the administrator PC 50, notification indicating completion of the processing such as installation and setting of a specific plug-in.

FIG. 21 is a flowchart illustrating the operation of the administrator PC 50. As illustrated in FIG. 21, at S400, the administrator PC 50 determines whether it has received the notification sent by the user PC 20 at S308 illustrated in FIG. 20. When the administrator PC 50 determines that it has not received the notification (No at S400), the process proceeds to S402. When the administrator PC 50 determines that it has received the notification (Yes at S400), the process is terminated.

At S402, the administrator PC 50 determines whether a predetermined time has passed. When the administrator PC 50 determines that the predetermined time has passed (Yes at S402), it determines that the user PC 20 fails to properly perform processing such as setting in the user PC 20, and the process proceeds to S404. When the administrator PC 50 determines that the predetermined time has not passed (No at S402), the process is terminated.

At S404, the administrator PC 50 distributes (redistributes) distribution information. The administrator PC 50 performs processing from S400 to S404 at predetermined timings. When the user PC 20 does not complete installation or setting after a predetermined time has passed, the administrator PC 50 redistributes distribution information. This enables the administrator to prompt the user to perform installation or setting operation.

Next, described is the operation of the user PC 20 performed when the user PC 20 requests a plug-in from the software management PC 12. FIG. 22 is a flowchart illustrating the operation of the user PC 20 performed when the user PC 20 requests a plug-in from the software management PC 12. As illustrated in FIG. 22, at S500, the user PC 20 determines whether it already has a plug-in specified in the distribution information. When the user PC 20 does not have the plug-in (No at S500), the process proceeds to S502. When the user PC 20 already has the plug-in (Yes at S500), the process proceeds to S514.

At S502, the user PC 20 acquires the plug-in. At S504, the user PC 20 starts installation of the plug-in (starts an installer application).

At S506, the user PC 20 sets information from the Admin as authentication information. Specifically, the user PC 20 reads, from the Admin 37 (FIG. 12), access right information indicating administrator right to the user PC 20, and displays a screen for asking approval of the user whose access right information is input in advance.

At S508, the user PC 20 determines whether the administrator right has been successfully authenticated. When, for example, the user PC 20 receives an input indicating that the administrator right has been successfully authenticated (Yes at S508), the process proceeds to S510. When the administrator right has not been successfully authenticated (No at S508), the process is terminated.

At S510, the user PC 20 installs the plug-in.

At S512, the user PC 20 sets the contents of a setting (setting information) illustrated in FIG. 17 on the plug-in.

At S514, the user PC 20 sets contents of a setting (setting information) corresponding to the plug-in that the user PC 20 already has.

At S516, the user PC 20 determines whether the setting has been completed. When the setting has not been completed (No at S516), the user PC 20 continues the processing until the setting is completed. When the user PC 20 determines that the setting has been completed (Yes at S516), the process proceeds to S518.

At S518, the user PC 20 transmits, to the administrator PC 50, notification indicating that the setting has been completed.

Next, described is the operation of the user PC 20 performed when the software management PC 12 transmits a plug-in to the user PC 20 according to an instruction from the administrator PC 50. FIG. 23 is a flowchart illustrating the operation of the user PC 20 performed when the software management PC 12 transmits a plug-in to the user PC 20 according to an instruction from the administrator PC 50. As illustrated in FIG. 23, at S600, the user PC 20 receives a plug-in transmitted by the administrator PC 50.

At S602, the user PC 20 starts installation of the plug-in (starts an installer application).

At S604, the user PC 20 sets information from the Admin as authentication information. Specifically, the user PC 20 reads, from the Admin 37 (FIG. 12), access right information indicating administrator right to the user PC 20, and displays a screen for asking approval of the user whose access right information is input in advance.

At S606, the user PC 20 determines whether the administrator right has been successfully authenticated. When, for example, the user PC 20 receives an input indicating that the administrator right has been successfully authenticated (Yes at S606), the process proceeds to S608. When the administrator right has not been successfully authenticated (No at S606), the process is terminated.

At S608, the user PC 20 installs the plug-in.

At S610, the user PC 20 determines whether the processing at S608 has been completed. When the user PC 20 determines that the processing at S608 has not been completed (No at S608), the user PC 20 continues the processing at S608. When the user PC 20 determines that the processing at S608 has been completed (Yes at S610), the process proceeds to S612.

At S612, the user PC 20 determines whether it has the contents of a setting (setting information), illustrated in FIG. 17, corresponding to the installed plug-in. When the user PC 20 determines that it has setting information corresponding to the plug-in (Yes at S612), the process proceeds to S614. When the user PC 20 determines that it does not have setting information corresponding to the plug-in (No at S612), the process is terminated.

At S614, the user PC 20 specifies a piece of setting information corresponding to the installed plug-in from a plurality of pieces of setting information.

At S616, the user PC 20 sets the piece of setting information specified at S614 on the plug-in.

At S618, the user PC 20 determines whether the processing at S616 has been completed. When the user PC 20 determines that the processing at S616 has not been completed (No at S618), the user PC 20 continues the processing at S616. When the user PC 20 determines that the processing at S616 has been completed (Yes at S618), the process proceeds to S620.

At S620, the user PC 20 transmits, to the administrator PC 50, notification indicating that the setting has been completed.

When the software management PC 12 transmits a plurality of plug-ins to the user PC 20 according to the instruction from the administrator PC 50, the user PC 20 is configured to specify settings corresponding to the respective plug-ins from a plurality of settings, and to perform setting processing on the respective plug-ins.

FIG. 24 is a flowchart illustrating the operation of the client in the comparative example performed when the client selects and installs a plug-in. As illustrated in FIG. 24, at S700, the client in the comparative example selects a plug-in to be installed on the client from a list of plug-ins according to an operation of the user.

At S702, the client acquires the plug-in selected at S700.

At S704, the client starts installation of the plug-in (starts an installer application).

At S706, the client displays a screen requesting the user to input Admin (administrator right).

At S708, the client receives an input of Admin from the user.

At S710, the client determines whether the administrator right has been successfully authenticated. For example, when the client receives an input indicating that the administrator right has been successfully authenticated (Yes at S710), the process proceeds to S712. When the administrator right has not been successfully authenticated (No at S710), the process is terminated.

At S712, the client installs the plug-in.

As described above, a setting for a plug-in that operates on a platform contains an attribute indicating whether to permit a change in the setting. This enables the administrator of software distributed via a network to restrict a change in a setting on the software.

The network system 10 enables the administrator to distribute, to apparatuses such as user PCs, information that the administrator wants to be installed or set on the apparatuses, and to manage the user PCs as to whether the user PCs perform and complete the installation or setting of the information.

The user PC 20, the administrator PC 50, and the software management PC 12 according to the embodiment include a control device such as a CPU, a storage device such as a read only memory (ROM) and a random access memory (RAM), an external storage device such as an HDD and a CD drive, a display device such as a display, and an input device such as a keyboard and a mouse, and have a hardware configuration using a normal computer. The information processing program executed on the user PC 20, the administrator PC 50, and the software management PC 12 according to the embodiment above is recorded and provided in a computer-readable recording medium such as a compact disc read only memory (CD-ROM), a flexible disk (FD), a compact disc recordable (CD-R), and a digital versatile disc (DVD), as an installable or executable file.

The information processing program executed on the user PC 20, the administrator PC 50, and the software management PC 12 according to the embodiment above may be stored in a computer connected to a network such as the Internet and provided by being downloaded via the network. Furthermore, the information processing program executed on the user PC 20, the administrator PC 50, and the software management PC 12 according to the embodiment above may be provided or distributed via a network such as the Internet. The information processing program according to the embodiments above may be embedded and provided in a ROM, for example.

In the embodiment above, the management system includes the output device 16 that is, for example, an image forming device, but it is not limited to this. The management system may include a device that transmits settings other than the image forming device.

According to an embodiment, an administrator can prompt users to use settings recommended and set by the administrator.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implemental on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A network system comprising:
a first information processing apparatus that transmits a setting set by an administrator for an application program; and
a second information processing apparatus connected to the first information processing apparatus via a network, wherein the second information processing apparatus comprises:
a communication unit that receives the setting set by the administrator for the application program;
an execution unit that executes the application program according to a setting;
a setting unit that stores therein and applies a setting for the application program;
a setting check unit that determines whether the set setting received by the communication unit and the setting stored in the setting unit match; and
a display unit that displays that the setting check unit determines that the set setting and the stored setting do not match.

2. The network system according to claim 1, wherein the first information processing apparatus transmits information indicating whether to cause the setting check unit to perform determination along with the setting set by the administrator for the application program.

3. The network system according to claim 1, further comprising a display control unit that receives input operation of changing the setting stored in the setting unit to change the setting, and displays a setting screen indicating the setting.

4. The network system according to claim 3, further comprising:
an output device that performs printing by an execution of the application program, wherein
the display control unit displays a preview of printing performed by the output device.

5. The network system according to claim 1, wherein the setting unit changes a current setting to the set setting when the setting check unit determines that the set setting and the current setting do not match.

6. The network system according to claim 1, wherein the setting transmitted by the first information processing apparatus contains an attribute indicating whether to permit a change in a setting on the second information processing apparatus.

7. An information processing apparatus comprising:
an execution unit that executes, according to a setting, an application program that operates on a platform;
a communication unit that receives a setting set by an administrator for the application program;
a setting unit that stores therein and applies a setting for the application program;
a setting check unit that determines whether the set setting received by the communication unit and the setting stored in the setting unit match; and
a display unit that displays that the setting check unit determines that the set setting and a current setting do not match.

8. The information processing apparatus according to claim 7, wherein the communication unit receives information indicating whether to cause the setting check unit to perform determination along with the setting set by the administrator for the application program.

9. The information processing apparatus according to claim 7, further comprising a display control unit that receives input operation of changing the setting stored in the setting unit to change the setting, and displays a setting screen indicating the setting.

10. The information processing apparatus according to claim 9, wherein the display control unit displays a preview of printing performed by an output device that performs printing by an execution of the application program.

11. The information processing apparatus according to claim 7, wherein the setting unit changes a current setting to the set setting when the setting check unit determines that the set setting and the current setting do not match.

12. The information processing apparatus according to claim 7, wherein the setting received by the communication unit contains an attribute indicating whether to permit a change in a setting on the information processing apparatus.

13. A computer program product comprising a non-transitory computer-usable medium having computer-readable program codes embodied in the medium for processing information in an information processing apparatus, wherein the program codes when executed cause a computer to execute:
storing a setting for an application program that operates on a platform;
receiving a setting set by an administrator for the application program;
determining whether the set setting received and the stored setting match; and
displaying that it is determined at the determining that the set setting and the stored setting do not match.

14. The computer program product according to claim 13, wherein the receiving includes receiving information indicating whether to perform the determining along with the setting set by the administrator for the application program.

15. The computer program product according to claim 13, wherein the program codes when executed cause the computer to further execute:
receiving input operation of changing the setting stored at the storing to change the setting; and
displaying a setting screen indicating the setting.

16. The computer program product according to claim 15, wherein the program codes when executed cause the computer to further execute:
displaying a preview of printing performed by an output device that performs printing by an execution of the application program.

17. The computer program product according to claim 13, wherein the program codes when executed cause the computer to further execute:
changing a current setting to the set setting when it is determined at the determining that the set setting and the current setting do not match.

18. The computer program product according to claim 13, wherein the setting received at the receiving contains an attribute indicating whether to permit a change in a setting on the information processing apparatus.
